(19) United States
(12) Patent Application Publication
(10) Pub. No.: US 2015/0109449 A1
(43) Pub. Date: Apr. 23, 2015

(54) VEHICULAR LAMP WITH A BUILT-IN CAMERA

(71) Applicant: KOITO MANUFACTURING CO., LTD., Tokyo (JP)

(72) Inventors: Osamu Endo, Shizuoka (JP); Hiroya Koizumi, Shizuoka (JP); Naoki Tatara, Shizuoka (JP)

(21) Appl. No.: 14/581,405

(22) Filed: Dec. 23, 2014

Related U.S. Application Data
(63) Continuation of application No. 13/023,742, filed on Feb. 9, 2011.

(30) Foreign Application Priority Data
Feb. 10, 2010 (JP) 2010-027649

(51) Int. Cl. B60Q 1/00; B60R 11/04; F21S 8/10

(52) U.S. Cl. CPC B60Q 1/0023; F21S 48/2268; B60R 11/04; B60R 2011/004
USPC 348/148

(57) ABSTRACT

A vehicular lamp includes a light source that illuminates a vehicle periphery; a camera that images the vehicle periphery; and a shield structure configured to protect an image from the camera from light of the light source. The shield structure may include a shield ring configured to shield a light receiving portion of the camera from light of the light source; a light guide member that guides the light of the light source in a direction away from the light receiving portion of the camera; a control circuit that operates the camera only at a timing when the light source, flashing in a short cycle, is off; and an image processing circuit that removes a colored light component of the light source from image data of the camera.

### BACKGROUND OF INVENTION

1. Field of the Invention

The present invention relates to a vehicular lamp with a built-in camera that images a vehicle periphery.

2. Related Art

In conventionally known art, a camera has been installed within a lamp chamber of a vehicular lamp so that a special camera housing is not necessary. For example, Patent Document 1 describes art in which a lamp chamber between a lamp housing and a translucent cover is vertically divided, with a lamp installed in a lower chamber and a camera installed in an upper chamber. A partition wall protects the camera from the heat generated by the lamp.

[Patent Document 1] Japanese Patent Application Laid-Open (Kokai) No. 2001-88610

### SUMMARY OF INVENTION

However, when a vehicular lamp with a built-in camera is used, the camera is susceptible to light incident from the lamp either directly or via the translucent cover. Therefore, reduced image quality occurs in conventional lamps due to incident light from the lamp when the lamp and the camera are simultaneously operated, such as at nighttime. It should be noted that Patent Document 1 proposes art that protects the camera from the heat of the lamp. However, Patent Document 1 does not touch on art that protects the camera from the light of the lamp.

In one or more embodiments, the present invention provides a vehicular lamp in which a high-quality image can be obtained even when a lamp and a camera are simultaneously operated.

In one or more embodiments, the present invention provides a vehicular lamp as described below.

(1) A vehicular lamp including: a lamp that illuminates a vehicle periphery; a camera that images the vehicle periphery; and means that protects an image of the camera from light of the lamp.

(2) The vehicular lamp according to (1), characterized in that the protection means includes a shield structure that shields a light receiving portion of the camera from the light of the lamp.

(3) The vehicular lamp according to (1) or (2), characterized in that the protection means includes a light guide member that guides the light of the lamp in a direction away from the light receiving portion of the camera.

(4) The vehicular lamp according to any one of (1) to (3), characterized in that the protection means includes a control circuit that operates the camera only at a timing when the lamp, flashing in a short cycle, is off.

(5) The vehicular lamp according to any one of (1) to (4), characterized in that the protection means includes an image processing circuit that removes a colored light component of the lamp from image data of the camera.

A vehicular lamp in accordance with one or more embodiments of the present invention has an effect in which an image from a camera is protected from light from a lamp by a shield structure, a light guide member, and/or an electronic control unit so that a high-quality image can be obtained even when the lamp and the camera are simultaneously operated.

Other aspects and advantages of the invention will be apparent from the following description, the drawings and the claims.

### BRIEF DESCRIPTION OF DRAWINGS

FIG. 1 is a horizontal cross-sectional view of a vehicular lamp that shows a first embodiment of the present invention.

FIGS. 2A-2E illustrate partial cross-sectional views of a vehicular lamp that show examples of modifications of the first embodiment.

FIG. 3 is a horizontal cross-sectional view of a vehicular lamp that shows a second embodiment of the present invention.

FIG. 4 is a frontal view of a vehicular lamp that shows a third embodiment of the present invention.

FIG. 5 is a vertical cross-sectional view of the vehicular lamp taken along a line V-V in FIG. 4.

FIG. 6 is a block diagram of an electronic control unit that shows a fourth embodiment of the present invention.

FIG. 7 is a time chart that shows a control of a camera and a lamp performed by the electronic control unit.

FIG. 8 is a flowchart that shows camera image processing performed by the electronic control unit.

### DETAILED DESCRIPTION

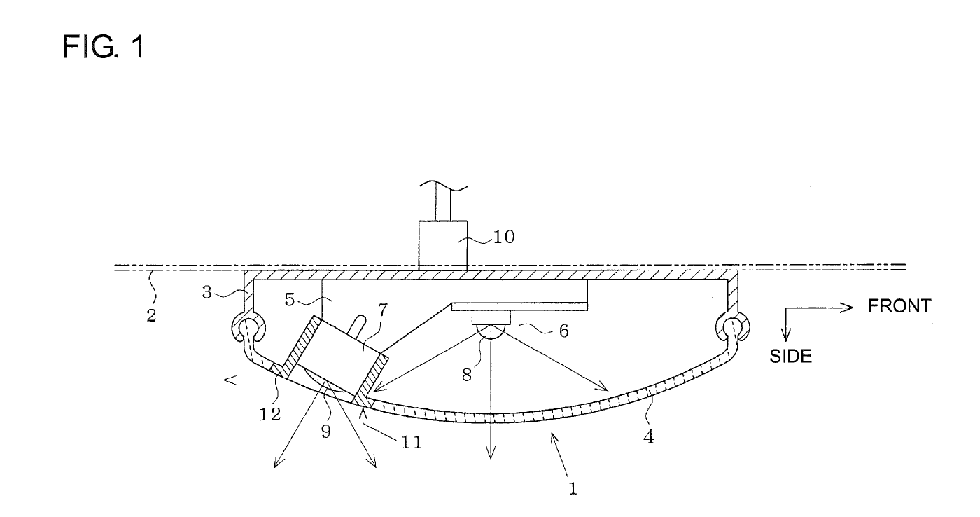

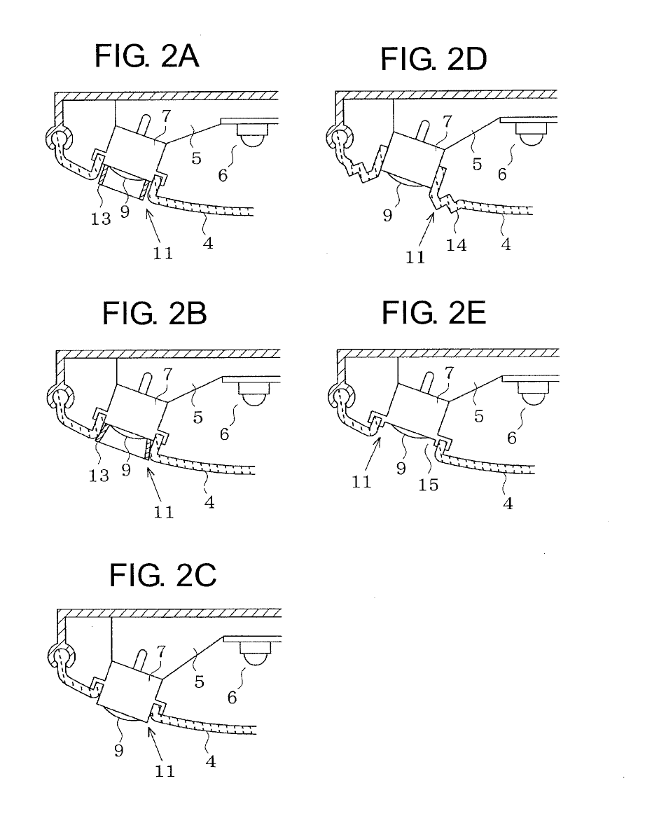

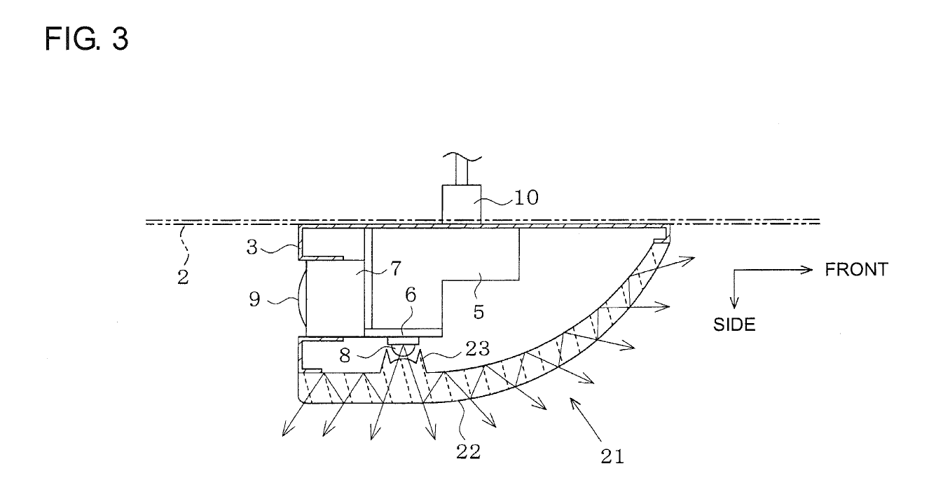

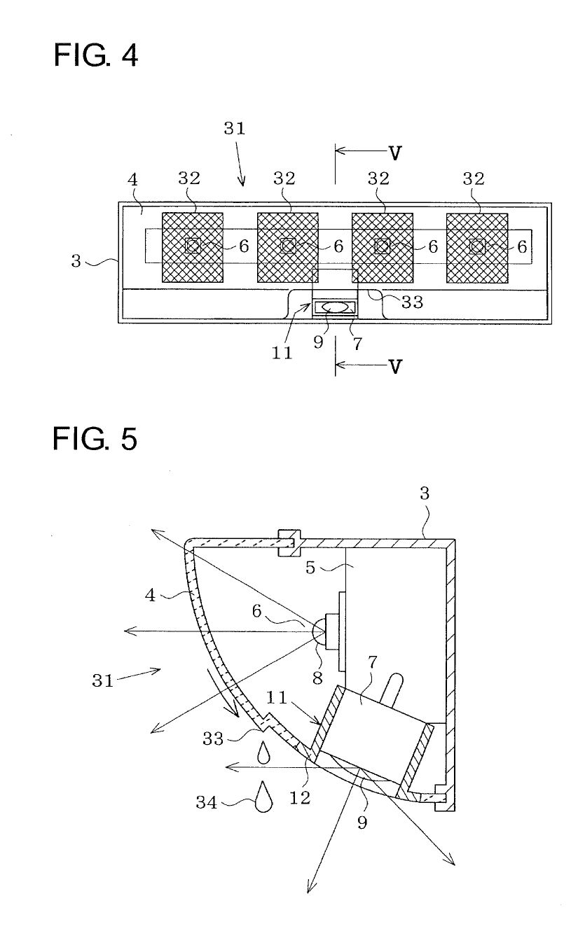

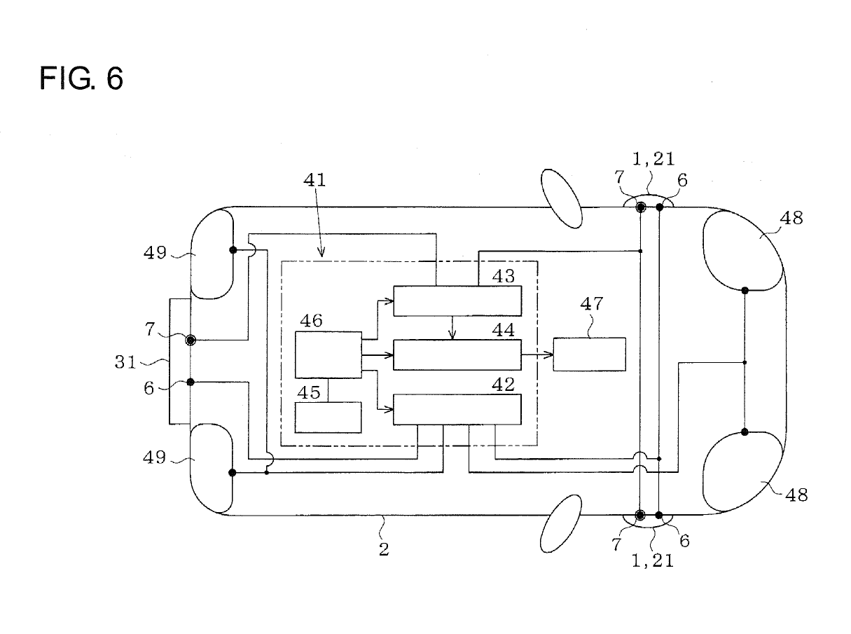

Hereinafter, the present invention will be described based on several embodiments with reference to the drawings. In a first embodiment shown in FIGS. 1 and 2 and a second embodiment shown in FIG. 3, the present invention is applied to a side turn signal lamp (STSL) on a side portion of an automobile. In a third embodiment shown in FIGS. 4 and 5, the present invention is applied to a high mounted stop lamp (HMSL) on a rear portion of an automobile. In a fourth embodiment shown in FIGS. 6 to 8, the present invention is applied to a control system of various types of vehicular lamps. In the embodiments, similar or like members are indicated by like reference numerals in the drawings.

### First Embodiment

As FIG. 1 shows, an STSL 1 according to the first embodiment includes a housing 3 that is attached to a side surface of a vehicle body 2, and a translucent cover 4 that covers the housing 3. A holder 5 is attached to an inner portion of the housing 3, and a lamp 6 and a camera 7 are installed on the holder 5. The lamp 6 includes a light source 8 that is formed of an LED or an incandescent bulb, and illuminates a vehicle sideward area with light from the light source 8. The camera 7 includes a light receiving lens 9 that faces obliquely rearward. The camera 7 images vehicle sideward and rearward areas with the light receiving lens 9, and displays such images on a monitor 47 (see FIG. 6) by a driver seat. Note that a wiring lead-out portion 10 of the lamp 6 and the camera 7 is provided on the holder 5 in an extending manner.

A shield structure 11 that shields the light receiving lens 9 from light from the lamp 6 is provided between the translucent cover 4 and the camera 7. In the shield structure 11 shown in FIG. 1, a shield ring 12 formed of opaque resin is two-color molded on the translucent cover 4 so as to surround the light receiving lens 9. The shield ring 12 blocks direct light from the light source 8 and indirect light from the translucent cover 4, and protects images taken by the camera 7 from the light of the lamp 6. Thus, even if the lamp 6 and the camera 7 are simultaneously operated, a high-quality image can be obtained, and vehicle sideward and rearward images can be clearly displayed on the monitor 47.

In FIG. 2A to FIG. 2E show examples of modifications of the shield structure 11. In the shield structure 11 shown in FIG. 2A, an opaque cylindrical partition 13 is interposed between the translucent cover 4 and the light receiving lens 9. The partition 13 shown in FIG. 2B has a tapered shape that opens outward. In the shield structure 11 shown in FIG. 2C, the camera 7 is held by the holder 5 such that the light receiving lens 9 projects from a surface of the translucent cover 4. In the shield structure 11 shown in FIG. 2D, a shield step 14 is formed on the translucent cover 4 so as to surround the light receiving lens 9. In the shield structure 11 shown in FIG. 2E, a wide shield space 15 is provided between the translucent cover 4 and the light receiving lens 9.

### Second Embodiment

As FIG. 3 shows, in an STSL 21 of the second embodiment, the holder 5 and a light guide member 22 are provided in the housing 3. On the holder 5, the lamp 6 is held facing outward and the camera 7 is installed facing rearward. The light guide member 22 is molded into a thick band configuration that is longitudinally long using transparent resin. In the light guide member 22, light from the light source 8 is incident from an incident portion 23 and then guided in a direction away from the light receiving lens 9 of the camera 7. Such light from the overall surface of the light guide member 22 illuminates a vehicle sideward area. Thus, with the constitution of the second embodiment as well, clear images of mainly rearward of the vehicle can be taken by the camera 7 without interference from the light of the lamp 6.

### Third Embodiment

As FIGS. 4 and 5 show, in an HMSL 31 of the third embodiment, the housing 3 is attached to a rear portion of the vehicle body 2 (see FIG. 6), with the lamp 6 held facing rearward on the holder 5 and a red lens portion 32 formed on the translucent cover 4 in a quantity matching the number of red light sources 8. The camera 7 is installed facing downward on the holder 5, and the shield structure 11 similar to that in the first embodiment and a rain cover portion 33 are provided on the translucent cover 4 at positions that correspond to the camera 7. The rain cover portion 33 is formed in a stepped configuration at a position higher than the light receiving lens 9, and allows rainwater 34 flowing down the translucent cover 4 to drip off before reaching the light receiving lens 9. Thus, with the third embodiment, images from the camera 7 can be protected from both rainwater and the light of the lamp 6.

### Fourth Embodiment

In the fourth embodiment shown in FIGS. 6 to 8, the images from the camera 7 are protected by a lamp electronic control unit (ECU) 41. As FIG. 6 shows, the lamp ECU 41 is constituted from a CPU 46 that includes a lamp control circuit 42 that controls the lamp 6, a camera control circuit 43 that controls the camera 7, an image processing circuit 44 that processes the images from the camera 7, and a storage portion 45. The following control is performed for vehicular lamps installed in various portions of the vehicle body 2, including a headlamp (HL) 48 and a rear combination lamp (RCL) 49, in addition to the STSLs 1, 21 of the first and second embodiments and the HMSL 31 of the third embodiment.

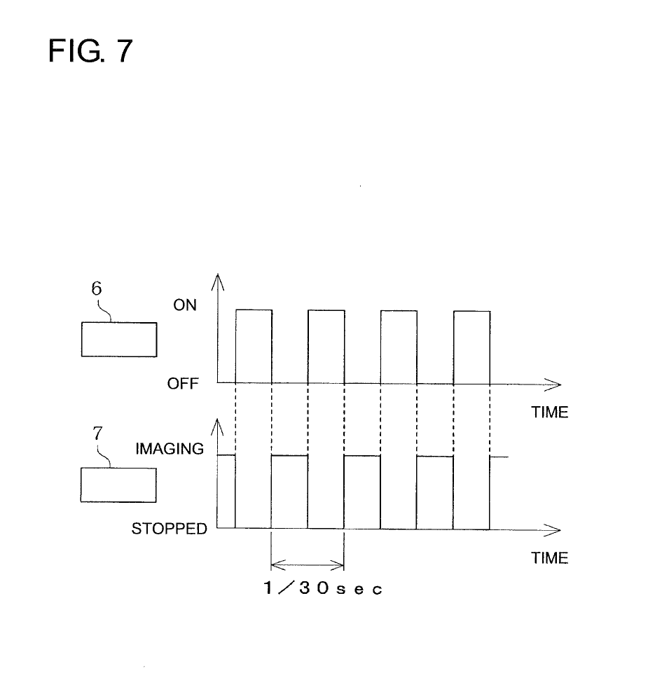

The lamp control circuit 42 controls turning the lamp 6 on and off in response to an operation of the driver. As FIG. 7 shows, while the lamp 6 is on, the light source 8 flashes on and off in very short cycles, e.g. 1/30 sec, such that light from the lamp 6 is still recognized as continuous light by the human eye. Meanwhile, the camera control circuit 43 controls the camera 7 to synchronize with the lamp 6 in a phase displaced by half a cycle so as to image the vehicle periphery only at a timing when the lamp 6 is off. Thus, even when the lamp 6 and the camera 7 are simultaneously operated, the light receiving lens 9 is less susceptible to light incident from the lamp 6 and the vehicle periphery can be clearly imaged by the camera 7.

The image processing circuit 44 performs processing to remove a colored light component of the lamp 6 from image data of the camera 7. The colored light component is mainly a red light component from the red light source 8 when a stop lamp of the HMSL 31 or the RCL 49 is turned on, and a light component that is colored red by the red lens portion 32 (see FIG. 4) of the translucent cover 4. In addition, the colored light component also includes a light component when the light source 8 is a red LED and the translucent cover 4 is clear (colorless and transparent) over its entire surface or colored red over its entire surface. The storage portion 45 stores in advance a reference value for performing a correction of the image data when a red light component is incident to the camera 7. For example, red light is made incident to the camera 7 in an environment with no ambient light, and an RGB component value calculated from the image data at such time is stored in the storage portion 45 as a correction reference value.

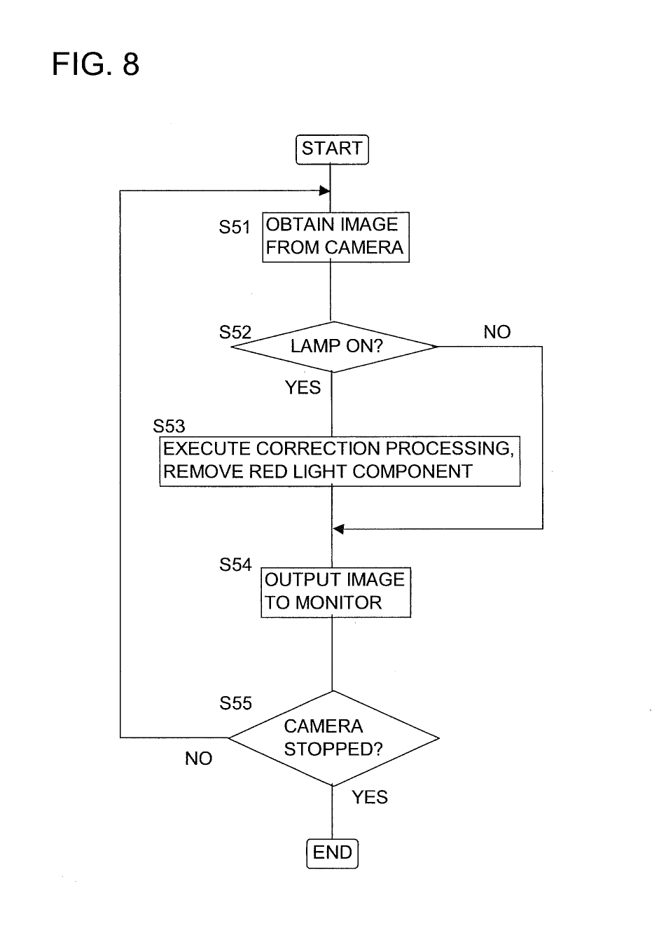

As FIG. 8 shows, during imaging by the camera 7, the image processing circuit 44 obtains image data from the camera 7 (S51). If the lamp 6 is on (S52), the image processing circuit 44 executes correction processing (S53). After using the correction reference value to remove the red light component from the image data, the image data is output to the monitor 47 (S54). The correction processing is not performed while the lamp 6 is off, and the images from the camera 7 are displayed without change on the monitor 47. If the camera 7 is confirmed as stopped (S55), the image processing is ended. Thus, even if the light of the lamp 6 is incident to the camera 7 via the red lens portion 32, an image of the vehicle periphery can be displayed on the monitor 47 with the same coloring as in real life.

Note that the characteristic art described in the first to fourth embodiments can be individually applied or appropriately applied in combination. The camera 7 may also be installed in the HL 48 and the RCL 49, and is not limited to installation in the STSLs 1, 21 and the HMSL 31. The present invention is not limited to the embodiments described above, and may be implemented by appropriately modifying configurations of various parts within the scope of the invention.

While description has been made in connection with exemplary embodiments of the present invention, it will be obvious to those skilled in the art that various changes and modification may be made therein without departing from the present invention. It is aimed, therefore, to cover in the appended claims all such changes and modifications falling within the true spirit and scope of the present invention.

### DESCRIPTION OF THE REFERENCE NUMERALS

1 STSL (FIRST EMBODIMENT)

2 VEHICLE BODY

3 HOUSING

4 TRANSLUCENT COVER

6 LAMP

7 CAMERA

9 LIGHT RECEIVING LENS

11 SHIELD STRUCTURE

21 STSL (SECOND EMBODIMENT)

22 LIGHT GUIDE MEMBER

31 HMSL (THIRD EMBODIMENT)

33 RAIN COVER PORTION

41 LAMP ECU (FOURTH EMBODIMENT)

42 LAMP CONTROL CIRCUIT

43 CAMERA CONTROL CIRCUIT

44 IMAGE PROCESSING CIRCUIT

1.-20. (canceled)

21. A vehicular lamp comprising:
a light source that emits light;
a camera; and
a light guide member,
wherein the camera comprises a light receiving lens disposed to face a direction different from a light emitting direction of the light source, and
wherein the light guide member comprises a light incident portion that receives light from the light source, directs light away from the light receiving lens, and irradiates light from a surface thereof.

22. The vehicular lamp according to claim 21,
wherein the vehicular lamp is configured to be disposed on a side of a vehicle,
wherein the light source is configured to be disposed on the side of the vehicle,
wherein the surface of the light guide member is configured to face the side of the vehicle, and
wherein the light receiving lens is configured to face a back of the vehicle.

23. The vehicular lamp according to claim 22,
wherein the light guide member is formed as a long strip that is configured to extend in a direction from a front of the vehicle to the back of the vehicle, and
wherein the light guide member guides light from the light incident portion and is configured to irradiate at least the front of the vehicle.

24. The vehicular lamp according to claim 22,
wherein the vehicular lamp is a side turn signal.

25. The vehicular lamp according to claim 21, further comprising:
a housing,
wherein the housing houses the camera, and
wherein the housing covers a perimeter of the light receiving lens and a side of the light source.

26. The vehicular lamp according to claim 21, further comprising:
a holder,
wherein the light source and the light receiving lens are integrally housed in the holder.

27. A vehicular lamp disposed on a vehicle comprising:
a light source that emits light;
a camera; and
a light guide member,
wherein the camera comprises a light receiving lens disposed to face a direction different from a light emitting direction of the light source, and
wherein the light guide member comprises a light incident portion that receives light from the light source, directs light away from the light receiving lens, and irradiates light from a surface thereof.

28. The vehicular lamp disposed on the vehicle according to claim 27,
wherein the vehicular lamp is disposed on a side of the vehicle,
wherein the light source is disposed on the side of the vehicle,
wherein the surface of the light guide member faces the side of the vehicle, and
wherein the light receiving lens faces a back of the vehicle.

29. The vehicular lamp disposed on the vehicle according to claim 28,
wherein the light guide member is formed as a long strip that extends in a direction from a front of the vehicle to the back of the vehicle, and
wherein the light guide member guides light from the light incident portion and irradiates at least the front of the vehicle.

30. The vehicular lamp disposed on the vehicle according to claim 28,
wherein the vehicular lamp is a side turn signal.

31. The vehicular lamp disposed on the vehicle according to claim 27, further comprising:
a housing,
wherein the housing houses the camera, and
wherein the housing covers a perimeter of the light receiving lens and a side of the light source.

32. The vehicular lamp disposed on the vehicle according to claim 27, further comprising:
a holder,
wherein the light source and the light receiving lens are integrally housed in the holder.
